(19) United States
(12) Patent Application Publication
(10) Pub. No.: US 2015/0281210 A1
(43) Pub. Date: Oct. 1, 2015

(54) PASSWORD-PROTECTED APPLICATION DATA FILE WITH DECOY CONTENT

(71) Applicant: BANK OF AMERICA CORPORATION, Charlotte, NC (US)

(72) Inventor: Andrea M. Weisberger, Jacksonville, FL (US)

(73) Assignee: BANK OF AMERICA CORPORATION, Charlotte, NC (US)

(21) Appl. No.: 14/230,326

(22) Filed: Mar. 31, 2014

(51) Int. Cl. H04L 29/06

(52) U.S. Cl. CPC H04L 63/083; H04L 63/164

(57) ABSTRACT

A computing platform may attempt to open a password-protected application data file. The computing platform may generate a prompt for a user to enter a password for the password-protected application data file. The computing platform may receive a user-inputted response to the prompt. The computing platform may determine whether the user-inputted response corresponds to a predetermined password for the password-protected application data file. Responsive to determining that the user-inputted response does not correspond to the predetermined password, the computing platform may display application-data-file content different from the application-data-file content generated by an author of the password-protected application data file to deter attempts at accessing protected data.

### BACKGROUND

Computer applications are increasingly being utilized by organizations and their employees. Often employees create multiple application data files during a single day. Due to their ubiquity, application data files are commonly exchanged between users (e.g., via email, file transfer protocols, file servers, and the like). Some application data files may contain sensitive, proprietary, and/or confidential content, and an organization or user may desire to prevent unauthorized access or viewing of such content. One approach to securing application data files is to configure them with password protection. Even when application data files are configured with password protection, however, they may be subject to unauthorized access. For example, an unauthorized user may attempt to determine the password for a password-protected application data file, by repeatedly trying different passwords until the application data file is successfully opened. Accordingly, a need exists for a password-protected application data file with decoy content, for example, to thwart continued attempts at unauthorized access to protected data.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

In accordance with one or more embodiments, a computing platform may attempt to open a password-protected application data file comprising application-data-file content generated by an author of the password-protected application data file. The computing platform may generate a prompt for a user to enter a password for the password-protected application data file. The computing platform may receive a user-inputted response to the prompt for the user to enter the password for the password-protected application data file. The computing platform may determine whether the user-inputted response to the prompt for the user to enter the password for the password-protected application data file corresponds to a predetermined password for the password-protected application data file. Responsive to determining that the user-inputted response to the prompt for the user to enter the password for the password-protected application data file does not correspond to the predetermined password for the password-protected application data file, the computing platform may display application-data-file content different from the application-data-file content generated by the author of the password-protected application data file.

In some embodiments, the computing platform may fail to display the application-data-file content generated by the author of the password-protected application data file.

In some embodiments, the password-protected application data file may be a word processor application data file. In such embodiments, the application-data-file content generated by the author of the password-protected application data file may include word processor application-data-file content generated by the author of the password-protected application data file, and displaying the application-data-file content different from the application-data-file content generated by the author of the password-protected application data file may include displaying word processor application-data-file content different from the word processor application-data-file content generated by the author of the password-protected application data file.

In some embodiments, the password-protected application data file may be a spreadsheet application data file. In such embodiments, the application-data-file content generated by the author of the password-protected application data file may include spreadsheet application-data-file content generated by the author of the password-protected application data file, and displaying the application-data-file content different from the application-data-file content generated by the author of the password-protected application data file may include displaying spreadsheet application-data-file content different from the spreadsheet application-data-file content generated by the author of the password-protected application data file.

In some embodiments, the password-protected application data file may be a presentation application data file. In such embodiments, the application-data-file content generated by the author of the password-protected application data file may include presentation application-data-file content generated by the author of the password-protected application data file, and displaying the application-data-file content different from the application-data-file content generated by the author of the password-protected application data file may include displaying presentation application-data-file content different from the presentation application-data-file content generated by the author of the password-protected application data file.

In some embodiments, displaying the application-data-file content different from the application-data-file content generated by the author of the password-protected application data file may include displaying a template application data file. In some embodiments, displaying the template application data file may include displaying a template application data file preselected by the author of the password-protected application data file. In some embodiments, the password-protected application data file may include a plurality of template application data files, and displaying the template application data file may include displaying a randomly selected template application data file of the plurality of template application data files.

In some embodiments, an error code thrown by an application executing on the computing platform and configured to open the password-protected application data file may be caught. The error code may indicate that the user-inputted response to the prompt for the user to enter the password for the password-protected application data file does not correspond to the predetermined password for the password-protected application data file. In some embodiments, responsive to catching the error code indicating that the user-inputted response to the prompt for the user to enter the password for the password-protected application data file does not correspond to the predetermined password for the password-protected application data file, the application executing on the computing platform may be prevented from displaying a graphical user interface element indicating that the user-inputted response to the prompt for the user to enter the password for the password-protected application data file does not correspond to the predetermined password for the password-protected application data file. In some embodiments, responsive to catching the error code indicating that the user-inputted response to the prompt for the user to enter the password for the password-protected application data file does not correspond to the predetermined password for the password-protected application data file, the application executing on the computing platform may close the password-protected application data file, and/or the application executing on the computing platform may display the application-data-file content different from the application-data-file content generated by the author of the password-protected application data file.

In some embodiments, the password-protected application data file may include a macro application. In such embodiments, catching the error code indicating that the user-inputted response to the prompt for the user to enter the password for the password-protected application data file does not correspond to the predetermined password for the password-protected application data file may include catching, by the macro application, the error code indicating that the user-inputted response to the prompt for the user to enter the password for the password-protected application data file does not correspond to the predetermined password for the password-protected application data file.

In some embodiments, the password-protected application data file may be overlaid with a wrapper application. In such embodiments, catching the error code indicating that the user-inputted response to the prompt for the user to enter the password for the password-protected application data file does not correspond to the predetermined password for the password-protected application data file may include catching, by an agent executing on the computing platform and configured to execute the wrapper application, the error code indicating that the user-inputted response to the prompt for the user to enter the password for the password-protected application data file does not correspond to the predetermined password for the password-protected application data file.

In some embodiments, responsive to determining that the user-inputted response to the prompt for the user to enter the password for the password-protected application data file does not correspond to the predetermined password for the password-protected application data file, the computing platform may generate a message indicating that an attempt to open the password-protected application data file using an incorrect password has been made, and may communicate the message indicating that the attempt to open the password-protected application data file using the incorrect password has been made to a different computing platform.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for generating and opening a password-protected application data file with decoy content in accordance with one or more example embodiments;

FIGS. 4A, 4B, and 4C depict example graphical user interfaces associated with opening a password-protected application data file in accordance with one or more example embodiments;

FIGS. 5A, 5B, and 5C depict example graphical user interfaces associated with an attempt to open a password-protected application data file using an incorrect password;

FIGS. 6A, 6B, and 6C depict example graphical user interfaces associated with an attempt to open a password-protected application data file with decoy content using an incorrect password in accordance with one or more example embodiments; and

FIG. 7 depicts an illustrative method for utilizing a password-protected application data file with decoy content in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

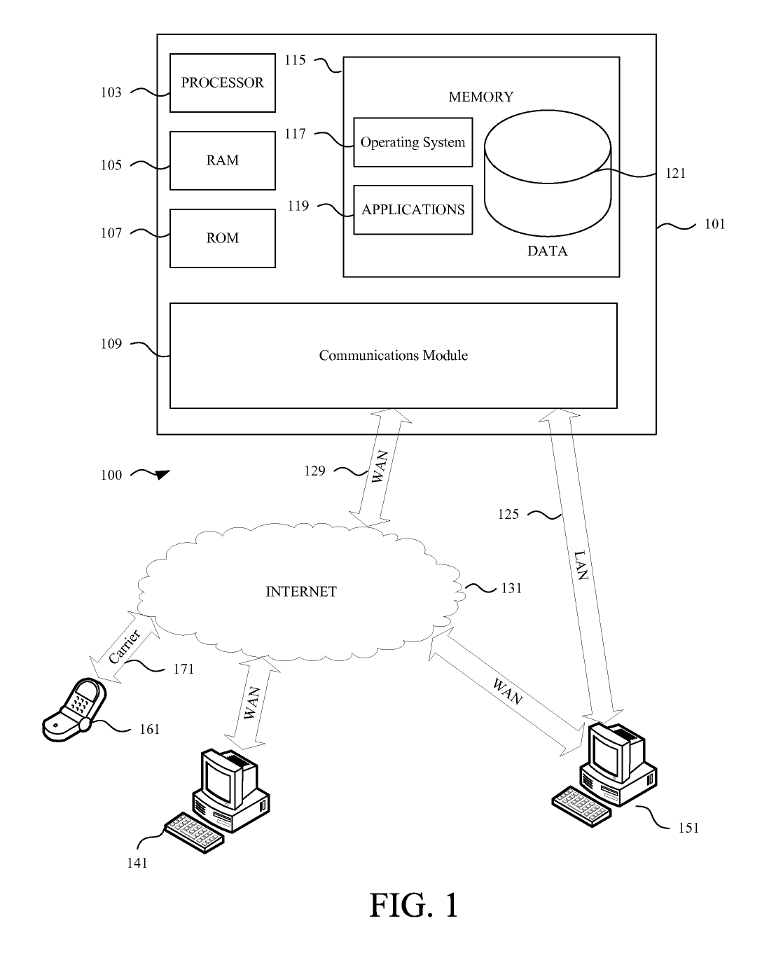

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

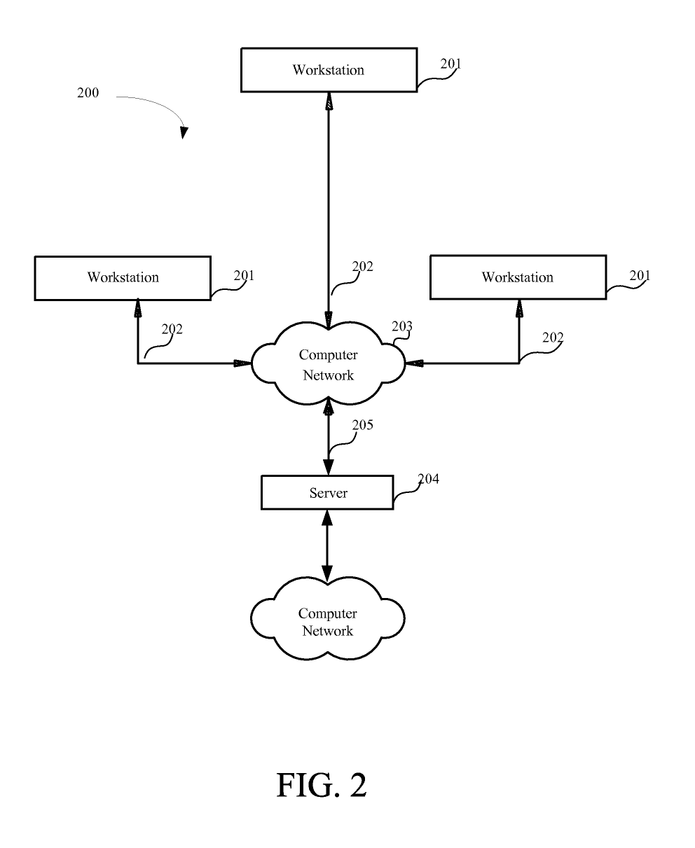

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

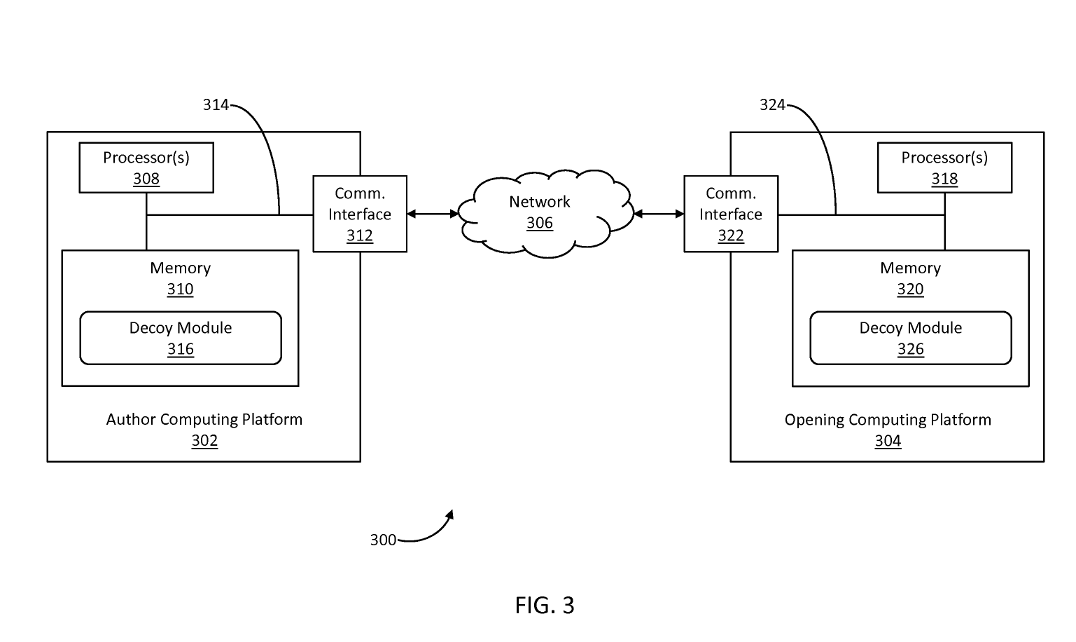

FIG. 3 depicts an illustrative computing environment for generating and opening a password-protected application data file with decoy content in accordance with one or more example embodiments. Referring to FIG. 3, computing environment 300 may include one or more computing platforms. For example, computing environment 300 may include author computing platform 302 and opening computing platform 304. Author computing platform 302 and/or opening computing platform 304 may include one or more computing devices configured to perform one or more of the functions described herein. For example, author computing platform 302 and/or opening computing platform 304 may include one or more computers (e.g., laptop computers, desktop computer, servers, server blades, tablet computers, mobile devices, smart phones, or the like). Computing environment 300 may also include one or more networks. For example, computing environment 300 may include network 306. Network 306 may include one or more sub-networks (e.g., LANs, WANs, or the like), which may interconnect author computing platform 302 and opening computing platform 304.

Author computing platform 302 may include one or more processor(s) 308, memory 310, communication interface 312, and data bus 314. Data bus 314 may interconnect processor(s) 308, memory 310, and/or communication interface 312. Communication interface 312 may be a network interface configured to support communication between author computing platform 302 and network 306, or one or more sub-networks thereof. Memory 310 may include one or more program modules comprising instructions that when executed by processor(s) 308 cause author computing platform 302 to perform one or more functions described herein. For example, memory 310 may include decoy module 316, which may comprise instructions that when executed by processor(s) 308 may cause author computing platform 302 to perform one or more functions described herein. Similarly, opening computing platform 304 may include one or more processor(s) 318, memory 320, communication interface 322, and data bus 324. Data bus 324 may interconnect processor(s) 318, memory 320, and/or communication interface 322. Communication interface 322 may be a network interface configured to support communication between opening computing platform 304 and network 306, or one or more sub-networks thereof. Memory 320 may include one or more program modules comprising instructions that when executed by processor(s) 318 cause opening computing platform 304 to perform one or more functions described herein. For example, memory 320 may include decoy module 326, which may comprise instructions that when executed by processor(s) 318 may cause opening computing platform 304 to perform one or more functions described herein.

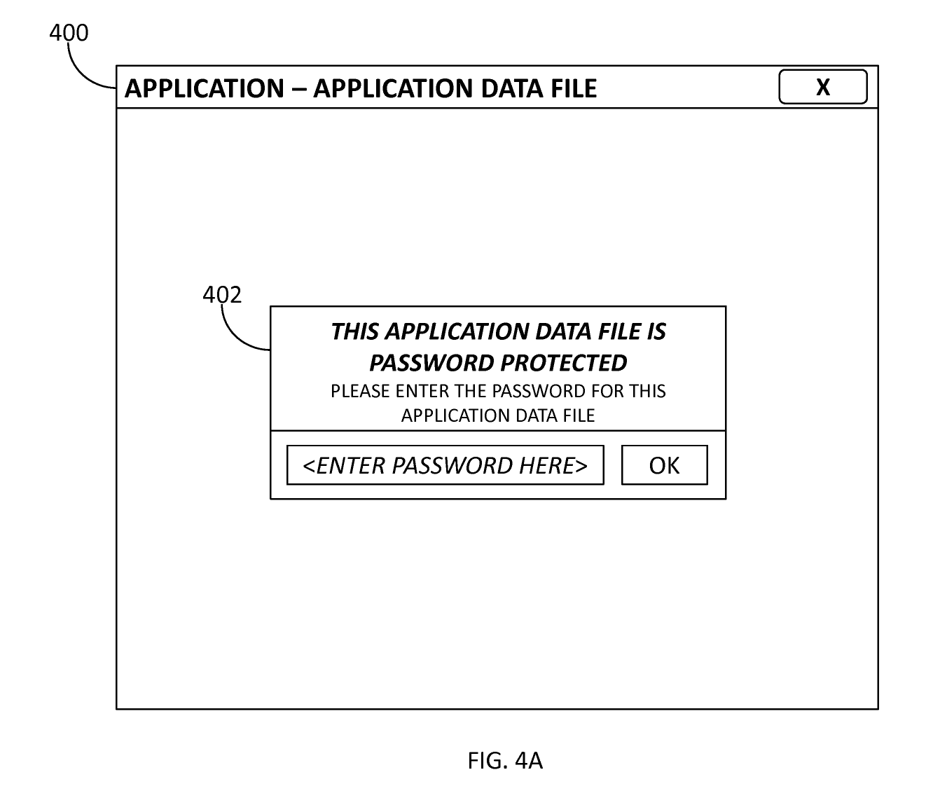

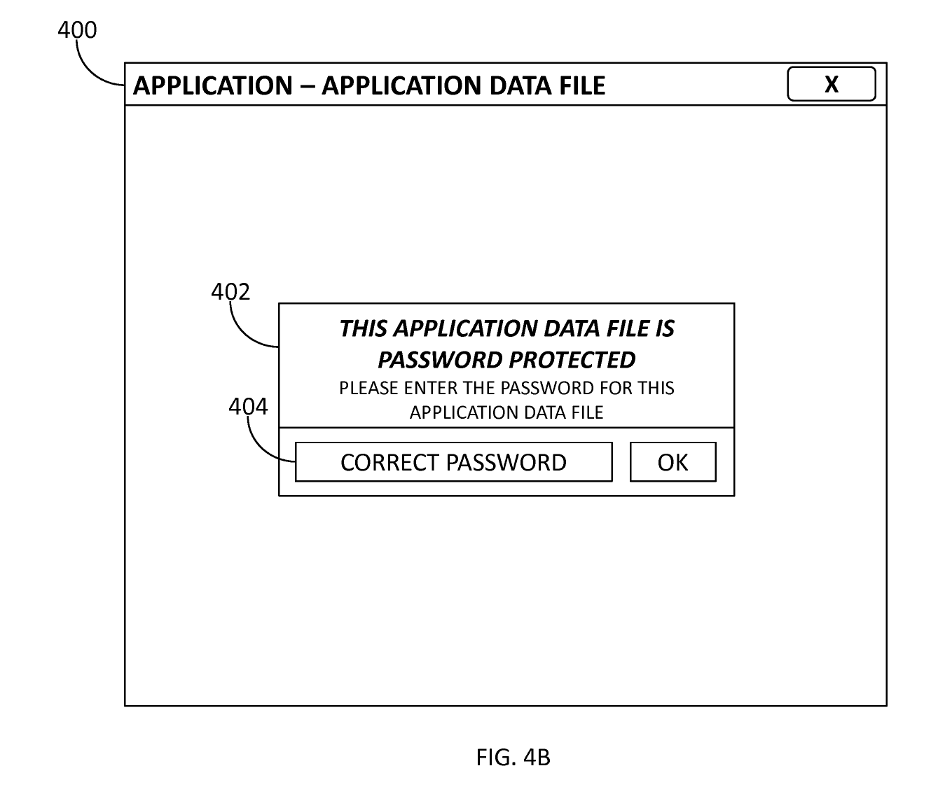

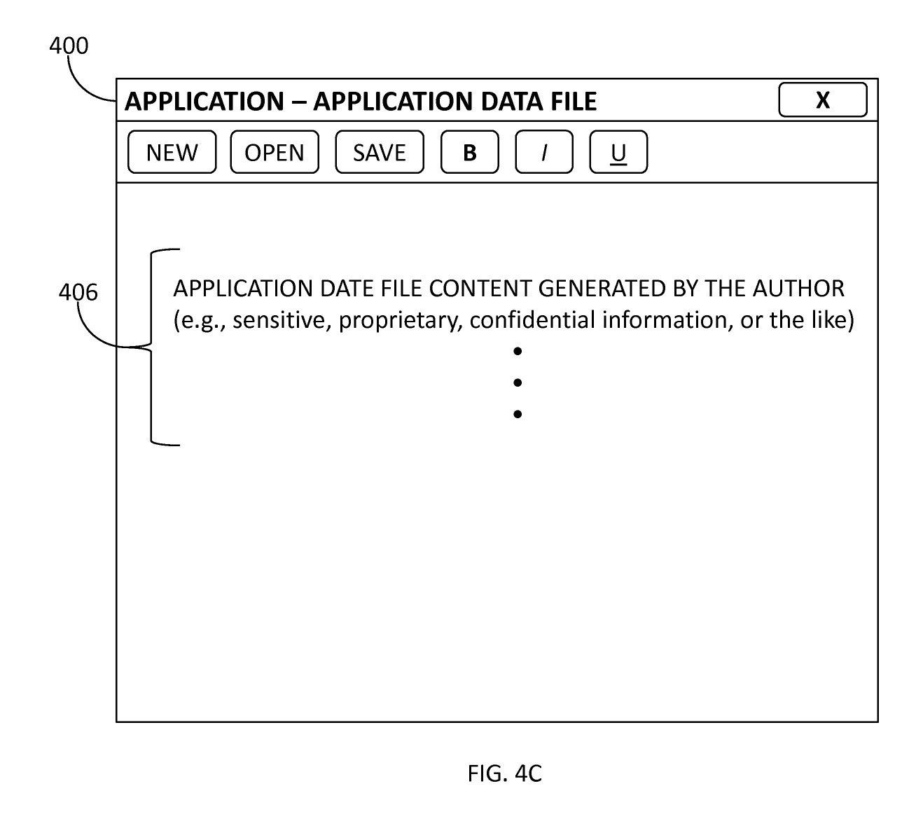

FIGS. 4A, 4B, and 4C depict example graphical user interfaces associated with opening a password-protected application data file in accordance with one or more example embodiments. A user of author computing platform 302 may generate an application data file (e.g., a word processor application data file, a spreadsheet application data file, a presentation application data file, or the like), which may include application-data-file content generated by an author of the application data file (e.g., the user of author computing platform 302). The application-data-file content generated by the author of the application data file may include sensitive, proprietary, or confidential information, or the like, and the user of author computing platform 302 may configure the application data file to be password protected. Opening computing platform 304 may receive (e.g., via communication interface 322) the password-protected application data file. An application executing on opening computing platform 304 and configured to open the password-protected application data file may attempt to open the password-protected application data file (e.g., a user of opening computing platform 304 may attempt to open the password-protected application data file). Referring to FIG. 4A, responsive to attempting to open the password-protected application data file, opening computing platform 304 may generate a prompt for a user to enter a password for the password-protected application data file. For example, opening computing platform 304 may generate a graphical user interface similar to graphical user interface 400, which may include graphical user interface element 402, prompting the user of opening computing platform 304 to enter a password for the password-protected application data file.

Opening computing platform 304 may receive a user-inputted response to the prompt for the user to enter the password for the password-protected application data file. For example, referring to FIG. 4B, the user of opening computing platform 304 may enter (e.g., via graphical user interface element 404) a predetermined (or “correct”) password for the password-protected application data file (e.g., a password specified by the user of author computing platform 302). Opening computing platform 304 may determine whether the user-inputted response to the prompt for the user to enter the password for the password-protected application data file corresponds to the predetermined password for the password-protected application data file (e.g., by comparing the “correct” password input via user interface element 404 with the predetermined password specified by the user of author computing platform 302). Referring to FIG. 4C, responsive to determining that the user-inputted response to the prompt for the user to enter the password for the password-protected application data file corresponds to the predetermined password for the password-protected application data file (e.g., determining that the “correct” password input via user interface element 404 matches the predetermined password specified by the user of author computing platform 302), opening computing platform 304 may display the application-data-file content generated by the author of the password-protected application data file. For example, opening computing platform 304 may display application-data-file content 406, which may include the application-data-file content generated by the user of author computing platform 302, or a portion thereof (e.g., the sensitive, proprietary, or confidential information, or the like).

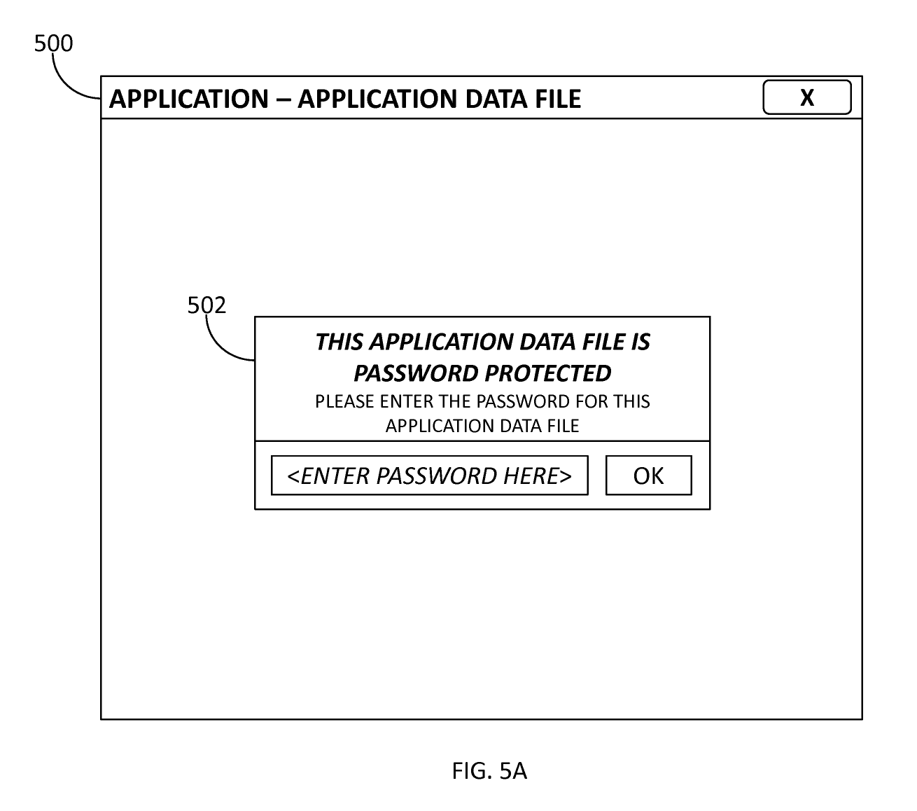

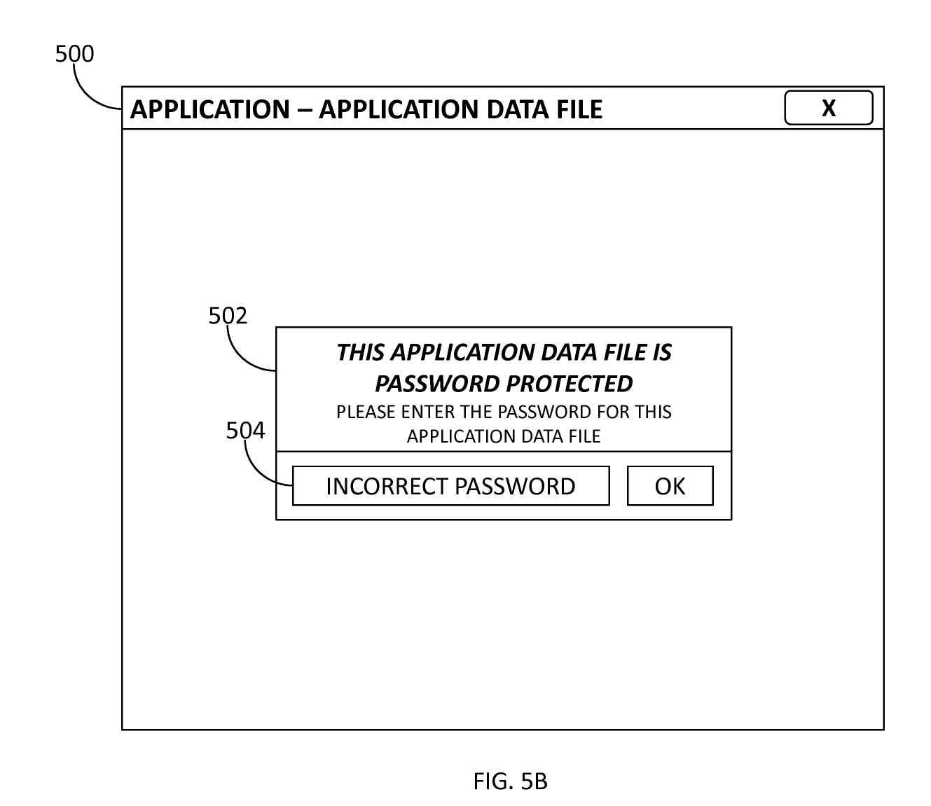

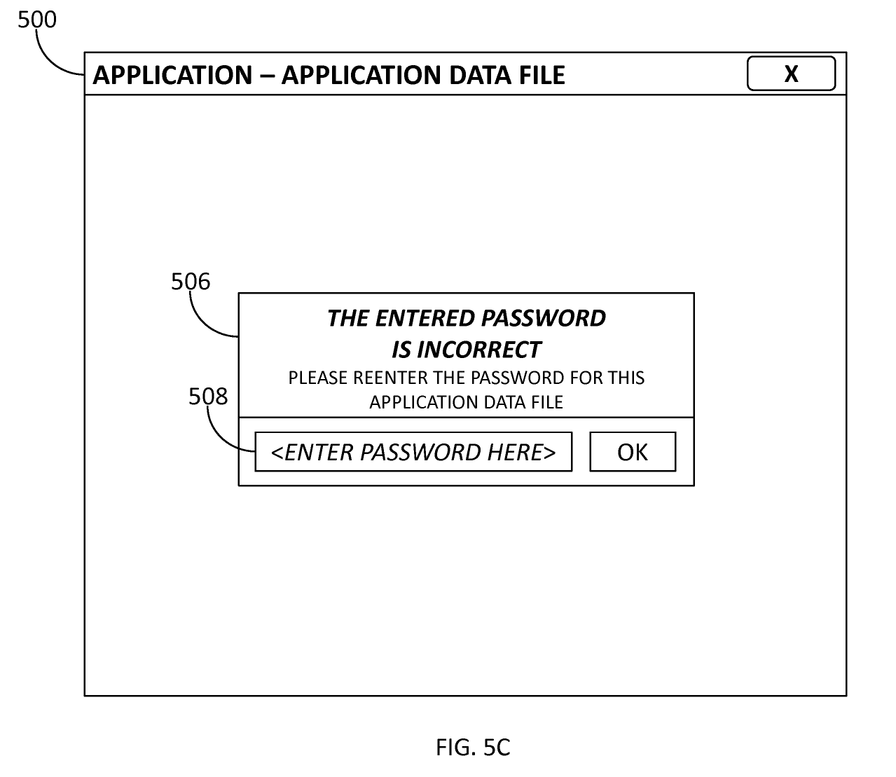

FIGS. 5A, 5B, and 5C depict example graphical user interfaces associated with an attempt to open a password-protected application data file using an incorrect password. As indicated above, a user of author computing platform 302 may generate an application data file (e.g., a word processor application data file, a spreadsheet application data file, a presentation application data file, or the like), which may include application-data-file content generated by an author of the application data file (e.g., the user of author computing platform 302). The application-data-file content generated by the author of the application data file may include sensitive, proprietary, or confidential information, or the like, and the user of author computing platform 302 may configure the application data file to be password protected. Opening computing platform 304 may receive (e.g., via communication interface 322) the password-protected application data file. An application executing on opening computing platform 304 and configured to open the password-protected application data file may attempt to open the password-protected application data file (e.g., a user of opening computing platform 304 may attempt to open the password-protected application data file). Referring to FIG. 5A, responsive to attempting to open the password-protected application data file, opening computing platform 304 may generate a prompt for a user to enter a password for the password-protected application data file. For example, opening computing platform 304 may generate a graphical user interface similar to graphical user interface 500, which may include graphical user interface element 502, prompting the user of opening computing platform 304 to enter a password for the password-protected application data file.

Opening computing platform 304 may receive a user-inputted response to the prompt for the user to enter the password for the password-protected application data file. For example, referring to FIG. 5B, the user of opening computing platform 304 may enter (e.g., via graphical user interface element 504) input different from a predetermined password for the password-protected application data file (e.g., a password different from a password specified by the user of author computing platform 302 (or an “incorrect” password)). Opening computing platform 304 may determine whether the user-inputted response to the prompt for the user to enter the password for the password-protected application data file corresponds to the predetermined password for the password-protected application data file (e.g., by comparing the “incorrect” password input via user interface element 504 with the predetermined password specified by the user of author computing platform 302). Referring to FIG. 5C, responsive to determining that the user-inputted response to the prompt for the user to enter the password for the password-protected application data file does not correspond to the predetermined password for the password-protected application data file (e.g., determining that the “incorrect” password input via user interface element 504 does not match the predetermined password specified by the user of author computing platform 302), opening computing platform 304 may generate and/or display a graphical user interface element indicating that the user-inputted response to the prompt for the user to enter the password for the password-protected application data file does not correspond to the predetermined password for the password-protected application data file. For example, opening computing platform 304 may generate and/or display graphical user interface element 506, which may indicate that the password input via user interface element 504 is incorrect, and may include a prompt (e.g., graphical user interface element 508) for the user of opening computing platform 304 to reenter (or enter a subsequent attempt) the password for the password-protected application data file. As will be appreciated and described in greater detail below, such an indication and/or prompt may notify the user of opening computing platform 304 that the password input via user interface element 504 is incorrect, and may encourage the user of opening computing platform 304 to continue to attempt to successfully open the password-protected application data file (e.g., guess the “correct” password).

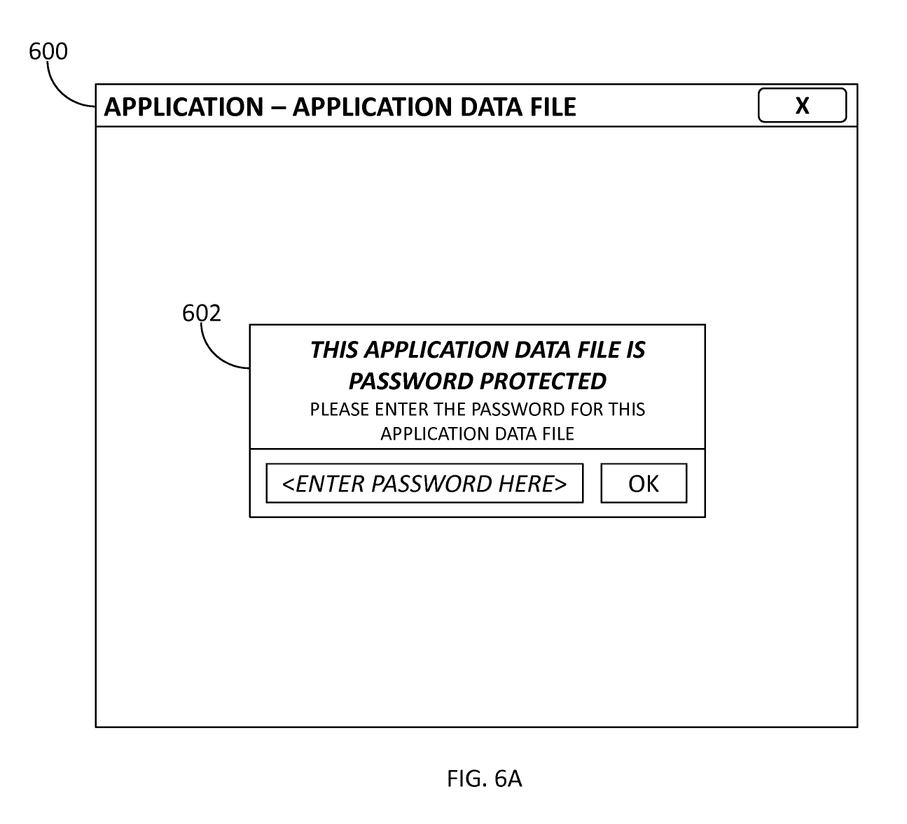

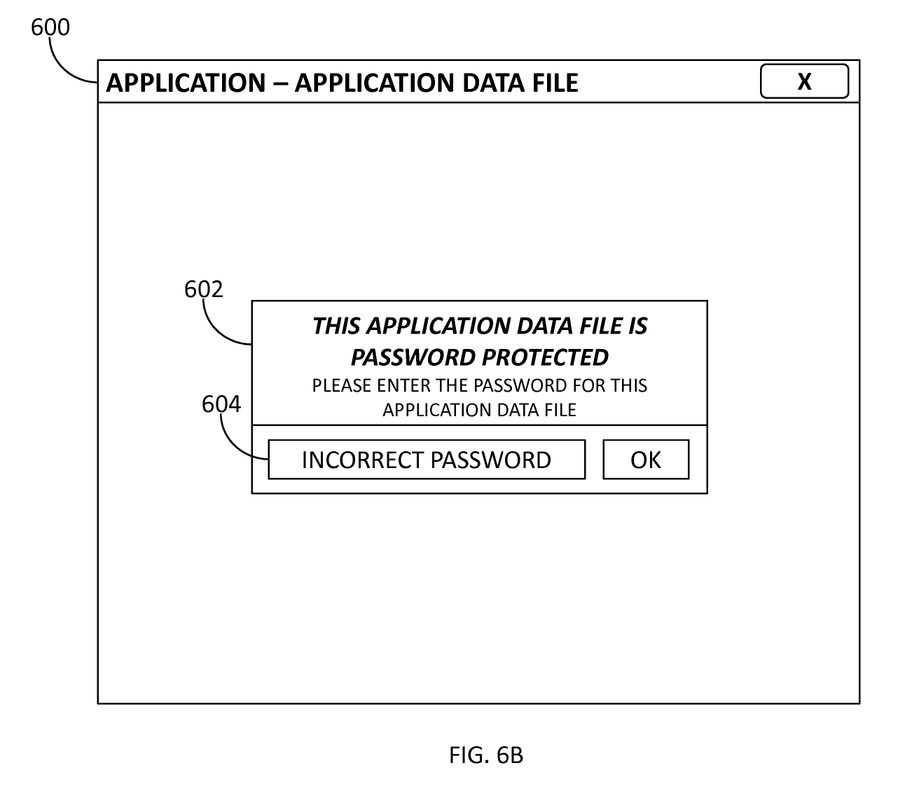

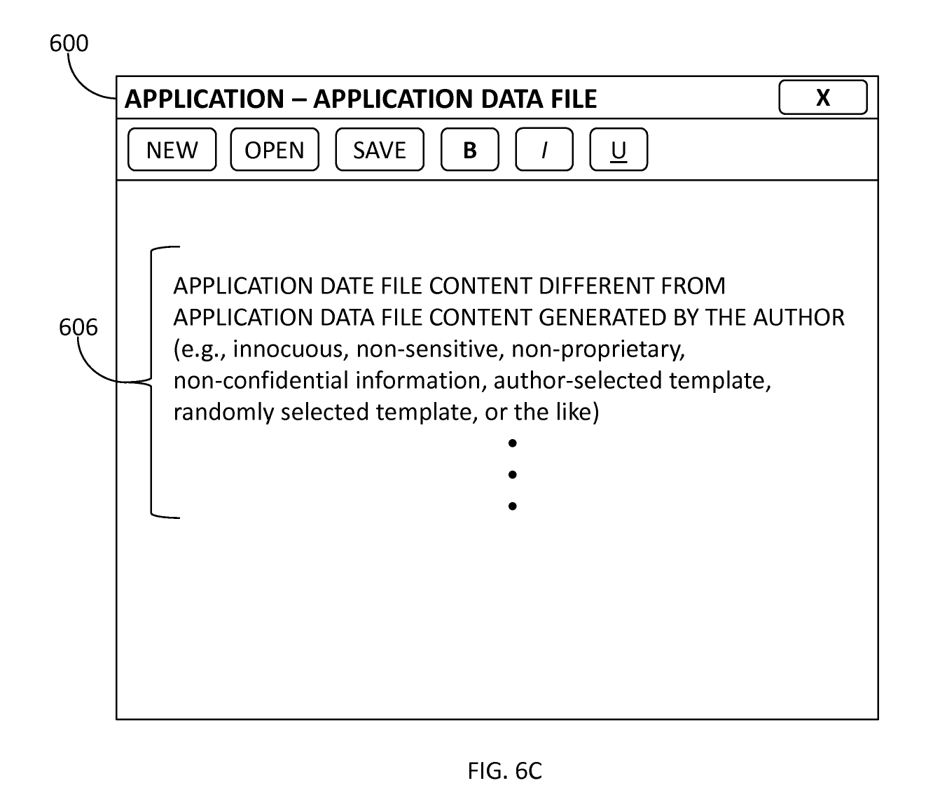

FIGS. 6A, 6B, and 6C depict example graphical user interfaces associated with an attempt to open a password-protected application data file with decoy content using an incorrect password in accordance with one or more example embodiments. Referring to FIG. 6A, as indicated above, a user of author computing platform 302 may generate an application data file (e.g., a word processor application data file, a spreadsheet application data file, a presentation application data file, or the like), which may include application-data-file content generated by an author of the application data file (e.g., the user of author computing platform 302). The application-data-file content generated by the author of the application data file may include sensitive, proprietary, or confidential information, or the like, and the user of author computing platform 302 may configure the application data file to be password protected. Opening computing platform 304 may receive (e.g., via communication interface 322) the password-protected application data file. An application executing on opening computing platform 304 and configured to open the password-protected application data file may attempt to open the password-protected application data file (e.g., a user of opening computing platform 304 may attempt to open the password-protected application data file). Referring to FIG. 6A, responsive to attempting to open the password-protected application data file, opening computing platform 304 may generate a prompt for a user to enter a password for the password-protected application data file. For example, opening computing platform 304 may generate a graphical user interface similar to graphical user interface 600, which may include graphical user interface element 602, prompting the user of opening computing platform 304 to enter a password for the password-protected application data file.

Opening computing platform 304 may receive a user-inputted response to the prompt for the user to enter the password for the password-protected application data file. For example, referring to FIG. 6B, the user of opening computing platform 304 may enter (e.g., via graphical user interface element 604) input different from a predetermined password for the password-protected application data file (e.g., a password different from a password specified by the user of author computing platform 302 (or an “incorrect” password)). Opening computing platform 304 may determine whether the user-inputted response to the prompt for the user to enter the password for the password-protected application data file corresponds to the predetermined password for the password-protected application data file (e.g., by comparing the “incorrect” password input via user interface element 604 with the predetermined password specified by the user of author computing platform 302). Referring to FIG. 6C, responsive to determining that the user-inputted response to the prompt for the user to enter the password for the password-protected application data file does not correspond to the predetermined password for the password-protected application data file (e.g., determining that the “incorrect” password input via user interface element 604 does not match the predetermined password specified by the user of author computing platform 302), opening computing platform 304 may fail to display the application-data-file content generated by the author of the password-protected application data file (e.g., the application-data-file content that includes the sensitive, proprietary, or confidential information, or the like), and may instead display decoy application-data-file content 606, which may be different from the application-data-file content generated by the author of the password-protected application data file (e.g., application data file content designed to give the user of opening computing platform 304 the impression that the “incorrect” password entered via user interface 604 was in fact “correct”). As will be appreciated, decoy application-data-file content 606 may fail to notify the user of opening computing platform 304 that the password input via user interface element 604 was incorrect, and may discourage the user of opening computing platform 304 from continuing to attempt to open the password-protected application data file (e.g., guess the “correct” password).

In some embodiments, the password-protected application data file may be a word processor application data file and the application-data-file content generated by the author of the password-protected application data file (e.g., the user of author computing platform 302) may include word processor application-data-file content generated by the author of the password-protected application data file (e.g., the application-data-file content that includes the sensitive, proprietary, or confidential information, or the like). In such embodiments, decoy application-data-file content 606 may be word processor application-data-file content different from the word processor application-data-file content generated by the author of the password-protected application data file.

In some embodiments, the password-protected application data file may be a spreadsheet application data file and the application-data-file content generated by the author of the password-protected application data file (e.g., the user of author computing platform 302) may include spreadsheet application-data-file content generated by the author of the password-protected application data file (e.g., the application-data-file content that includes the sensitive, proprietary, or confidential information, or the like). In such embodiments, decoy application-data-file content 606 may be spreadsheet application-data-file content different from the spreadsheet application-data-file content generated by the author of the password-protected application data file.

In some embodiments, the password-protected application data file may be a presentation application data file and the application-data-file content generated by the author of the password-protected application data file (e.g., the user of author computing platform 302) may include presentation application-data-file content generated by the author of the password-protected application data file (e.g., the application-data-file content that includes the sensitive, proprietary, or confidential information, or the like). In such embodiments, decoy application-data-file content 606 may be presentation application-data-file content different from the presentation application-data-file content generated by the author of the password-protected application data file.

In some embodiments, decoy application-data-file content 606 may comprise template application-data-file content. In some embodiments, the template application-data-file content may have been preselected by the author of the password-protected application data file (e.g., the user of author computing platform 302). Additionally or alternatively, the password-protected application data file may include a plurality of template application data files, and the template application-data-file content may be randomly selected from the plurality of included template application data files.

In some embodiments, the application executing on opening computing platform 304 and configured to open the password-protected application data file may throw an error code indicating that the user-inputted response to the prompt for the user to enter the password for the password-protected application data file (e.g., the “incorrect” password input via user interface element 604) does not correspond to the predetermined password for the password-protected application data file. Such an error code may be caught, and, responsive to catching the error code, the application executing on opening computing platform 304 may be prevented from displaying a graphical user interface element indicating that the user-inputted response to the prompt for the user to enter the password for the password-protected application data file does not correspond to the predetermined password for the password-protected application data file (e.g., a graphical user interface element similar to graphical user interface element 506). Additionally or alternatively, responsive to catching the error code, the application executing on opening computing platform 304 may close the password-protected application data file, and/or the application executing on opening computing platform may display decoy application-data-file content 606.

In some embodiments, the password-protected application data file may include a macro application. In such embodiments, the macro application may catch the error code, and, responsive to catching the error code, may display decoy application-data-file content 606, and/or cause opening computing platform 304 to perform one or more of the functions described herein. Additionally or alternatively, the password-protected application data file may be overlaid with a wrapper application, and an agent executing on opening computing platform 304 and configured to execute the wrapper application, may catch the error code, and, responsive to catching the error code, may display decoy application-data-file content 606, and/or cause opening computing platform 304 to perform one or more of the functions described herein.

In some embodiments, responsive to determining that the user-inputted response to the prompt for the user to enter the password for the password-protected application data file does not correspond to the predetermined password for the password-protected application data file, opening computing platform 304 may generate a message indicating that an attempt to open the password-protected application data file using an incorrect password has been made, and may communicate the message to a different computing platform (e.g., author computing platform 302).

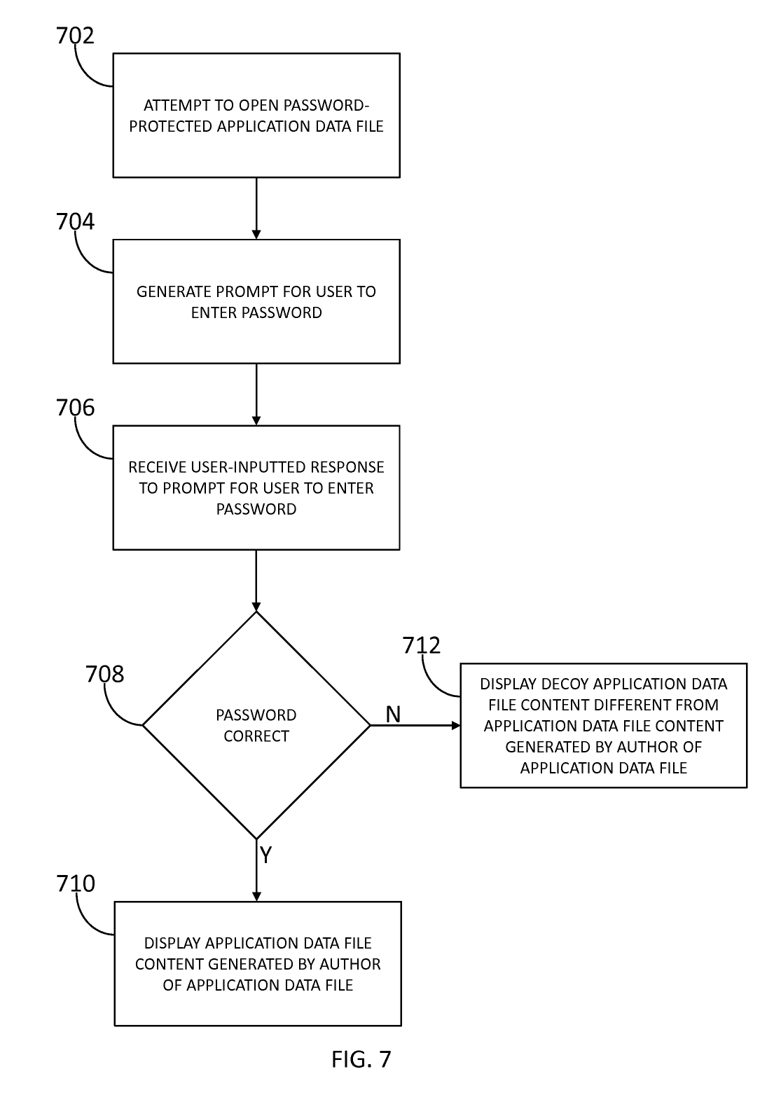

FIG. 7 depicts an illustrative method for utilizing a password-protected application data file with decoy content in accordance with one or more example embodiments. Referring to FIG. 7, at step 702, a computing platform may attempt to open a password-protected application data file comprising application-data-file content generated by an author of the password-protected application data file. For example, opening computing platform 304 may attempt to open the password-protected application data file comprising the application-data-file content generated by the user of author computing platform 302. At step 704, the computing platform may generate a prompt for a user to enter a password for the password-protected application data file. For example, opening computing platform 304 may generate a graphical user interface comprising a graphical user interface element similar to graphical user interface element 402, 502, and/or 602. At step 706, the computing platform may receive a user-inputted response to the prompt for the user to enter the password for the password-protected application data file. For example, opening computing platform 304 may receive a response input by the user of opening computing platform 304 (e.g., via graphical user interface element 404, 504, and/or 604).

At step 708, the computing platform may determine whether the user-inputted response to the prompt for the user to enter the password for the password-protected application data file corresponds to a predetermined password for the password-protected application data file. For example, opening computing platform 304 may determine whether the response input by the user of opening computing platform 304 corresponds to a predetermined password for the password-protected application data file (e.g., the password specified by the user of author computing platform 302). Responsive to determining that the user-inputted response to the prompt for the user to enter the password for the password-protected application data file corresponds to the predetermined password for the password-protected application data file, at step 710, the computing platform may display the application-data-file content generated by the author of the password-protected application data file. For example, opening computing platform 304 may display application-data-file content 406, which may include the application-data-file content generated by the user of author computing platform 302, or a portion thereof (e.g., the sensitive, proprietary, or confidential information, or the like). Returning to step 708, responsive to determining that the user-inputted response to the prompt for the user to enter the password for the password-protected application data file does not correspond to the predetermined password for the password-protected application data file, at step 712, the computing platform may display application-data-file content different from the application-data-file content generated by the author of the password-protected application data file. For example, opening computing platform 304 may display decoy application-data-file content 606, which may be different from the application-data-file content generated by the author of the password-protected application data file (e.g., application data file content designed to give the user of opening computing platform 304 the impression that the “incorrect” password entered was in fact “correct”).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
attempting to open, by a computing platform comprising at least one processor, a password-protected application data file comprising application-data-file content generated by an author of the password-protected application data file;
generating, by the computing platform, a prompt for a user to enter a password for the password-protected application data file;
receiving, by the computing platform, a user-inputted response to the prompt for the user to enter the password for the password-protected application data file;
determining, by the computing platform, whether the user-inputted response to the prompt for the user to enter the password for the password-protected application data file corresponds to a predetermined password for the password-protected application data file; and
responsive to determining that the user-inputted response to the prompt for the user to enter the password for the password-protected application data file does not correspond to the predetermined password for the password-protected application data file, displaying, by the computing platform, application-data-file content different from the application-data-file content generated by the author of the password-protected application data file.

2. The method of claim 1, comprising failing to display the application-data-file content generated by the author of the password-protected application data file.

3. The method of claim 1, wherein the password-protected application data file comprises a word processor application data file, wherein the application-data-file content generated by the author of the password-protected application data file comprises word processor application-data-file content generated by the author of the password-protected application data file, and wherein displaying the application-data-file content different from the application-data-file content generated by the author of the password-protected application data file comprises displaying word processor application-data-file content different from the word processor application-data-file content generated by the author of the password-protected application data file.

4. The method of claim 1, wherein the password-protected application data file comprises a spreadsheet application data file, wherein the application-data-file content generated by the author of the password-protected application data file comprises spreadsheet application-data-file content generated by the author of the password-protected application data file, and wherein displaying the application-data-file content different from the application-data-file content generated by the author of the password-protected application data file comprises displaying spreadsheet application-data-file content different from the spreadsheet application-data-file content generated by the author of the password-protected application data file.

5. The method of claim 1, wherein the password-protected application data file comprises a presentation application data file, wherein the application-data-file content generated by the author of the password-protected application data file comprises presentation application-data-file content generated by the author of the password-protected application data file, and wherein displaying the application-data-file content different from the application-data-file content generated by the author of the password-protected application data file comprises displaying presentation application-data-file content different from the presentation application-data-file content generated by the author of the password-protected application data file.

6. The method of claim 1, wherein displaying the application-data-file content different from the application-data-file content generated by the author of the password-protected application data file comprises displaying a template application data file.

7. The method of claim 6, wherein displaying the template application data file comprises displaying a template application data file preselected by the author of the password-protected application data file.

8. The method of claim 6, wherein the password-protected application data file comprises a plurality of template application data files, and wherein displaying the template application data file comprises displaying a randomly selected template application data file of the plurality of template application data files.

9. The method of claim 1, comprising catching an error code thrown by an application executing on the computing platform and configured to open the password-protected application data file, the error code indicating that the user-inputted response to the prompt for the user to enter the password for the password-protected application data file does not correspond to the predetermined password for the password-protected application data file.

10. The method of claim 9, comprising, responsive to catching the error code indicating that the user-inputted response to the prompt for the user to enter the password for the password-protected application data file does not correspond to the predetermined password for the password-protected application data file, preventing the application executing on the computing platform from displaying a graphical user interface element indicating that the user-inputted response to the prompt for the user to enter the password for the password-protected application data file does not correspond to the predetermined password for the password-protected application data file.

11. The method of claim 9, comprising, responsive to catching the error code indicating that the user-inputted response to the prompt for the user to enter the password for the password-protected application data file does not correspond to the predetermined password for the password-protected application data file:
closing, by the application executing on the computing platform, the password-protected application data file; and
displaying, by the application executing on the computing platform, the application-data-file content different from the application-data-file content generated by the author of the password-protected application data file.

12. The method of claim 9, wherein the password-protected application data file comprises a macro application, and wherein catching the error code indicating that the user-inputted response to the prompt for the user to enter the password for the password-protected application data file does not correspond to the predetermined password for the password-protected application data file comprises catching, by the macro application, the error code indicating that the user-inputted response to the prompt for the user to enter the password for the password-protected application data file does not correspond to the predetermined password for the password-protected application data file.

13. The method of claim 9, wherein the password-protected application data file is overlaid with a wrapper application, and wherein catching the error code indicating that the user-inputted response to the prompt for the user to enter the password for the password-protected application data file does not correspond to the predetermined password for the password-protected application data file comprises catching, by an agent executing on the computing platform and configured to execute the wrapper application, the error code indicating that the user-inputted response to the prompt for the user to enter the password for the password-protected application data file does not correspond to the predetermined password for the password-protected application data file.

14. The method of claim 1, comprising, responsive to determining that the user-inputted response to the prompt for the user to enter the password for the password-protected application data file does not correspond to the predetermined password for the password-protected application data file:
generating a message indicating that an attempt to open the password-protected application data file using an incorrect password has been made; and
communicating, the message indicating that the attempt to open the password-protected application data file using the incorrect password has been made, to a different computing platform.

15. An apparatus, comprising:
at least one processor; and
a memory storing instructions that when executed by the at least one processor cause the apparatus to:
determine whether a user-inputted response to a prompt for a user to enter a password for a password-protected application data file corresponds to a predetermined password for the password-protected application data file; and
responsive to determining that the user-inputted response to the prompt for the user to enter the password for the password-protected application data file does not correspond to the predetermined password for the password-protected application data file, display application-data-file content different from application-data-file content generated by an author of the password-protected application data file.

16. The apparatus of claim 15, wherein the instructions, when executed by the at least one processor, cause the apparatus to catch an error code thrown by an application executing on the apparatus and configured to open the password-protected application data file, the error code indicating that the user-inputted response to the prompt for the user to enter the password for the password-protected application data file does not correspond to the predetermined password for the password-protected application data file.

17. The apparatus of claim 15, wherein the application-data-file content different from the application-data-file content generated by the author of the password-protected application data file comprises a template.

18. One or more non-transitory computer-readable media having instructions stored thereon that when executed by one or more computers cause the one or more computers to:
attempt to open a password-protected application data file;
prompt a user to enter a password for the password-protected application data file;
determine that a password entered by the user is incorrect; and
responsive to determining that the password entered by the user is incorrect, display decoy application data file content designed to give the user the impression that the password entered by the user was correct.

19. The one or more non-transitory computer-readable media of claim 18, wherein the decoy application data file content comprises a template.

20. The one or more non-transitory computer-readable media of claim 18, wherein the instructions, when executed by the one or more computers, cause the one or more computers to catch an error code thrown by an application executing on the one or more computers and configured to open the password-protected application data file, the error code indicating that the password entered by the user is incorrect.
